(19) United States
(12) Patent Application Publication
(10) Pub. No.: US 2010/0180632 A1
(43) Pub. Date: Jul. 22, 2010

(54) PILEUS-GILLS TYPE HELIUM CONDENSER AND APPARATUS INCLUDING THE SAME

(75) Inventors: Bong Hwan Hong, Seoul (KR); Yu Seok Kim, Seoul (KR); Joonsun Kang, Seoul (KR); Dong Hyun An, Seoul (KR); In Su Jung, Seoul (KR); Hong Suk Chang, Yongin (KR); Kun Uk Kang, Seoul (KR)

Correspondence Address: Jason Y. Pahng and Associates, LLC, 12178 Bridgend Run, Fairfax, VA, 22030, US

(73) Assignee: KOREA INSTITUTE OF RADIOLOGICAL & MEDICAL SCIENCES, Seoul (KR)

(21) Appl. No.: 12/499,061

(22) Filed: Jul. 7, 2009

(30) Foreign Application Priority Data
Jan. 16, 2009 (KR) 10-2009-0003739

(51) Int. Cl. F25J 1/00; F17C 13/00

(52) U.S. Cl. 62/608; 62/48.2

(57) ABSTRACT

Provided are a pileus-gills type helium condenser and an apparatus, including the same, for condensing helium. The pileus-gills type helium condenser includes: a body having a hemispheric shape and formed of a highly thermally conductive metal; a plurality of cooling fins collectively having a pileus gills-like shape and arranged along the circumference of the body to be spaced apart from one another; and a through-hole formed in the center of the body to be adjacent to the cooling fins.

### CROSS-REFERENCE TO RELATED PATENT APPLICATION

This application claims the benefit of Korean Patent Application No. 10-2009-0003739, filed on Jan. 16, 2009, in the Korean Intellectual Property Office, the disclosure of which is incorporated herein in its entirety by reference.

### BACKGROUND OF THE INVENTION

1. Field of the Invention

The present invention relates to a helium condenser for recondensing helium gas resulting from the evaporation of liquid helium contained in an insulated tank, and an apparatus including the helium condenser.

The present invention is derived from a research project supported by the Atomic Energy Research & Development (R&D) Program of the Ministry of Education, Science, and Technology [M2070605000108M060500110, Development of Superconducting Cyclotron Main Technology].

2. Description of the Related Art

In general, liquid helium boils at a temperature of 4 K, and is used in a device, such as a small measuring device requiring a very low temperature, an electromagnet for a magnetic resonance imaging device, or a superconducting cyclotron.

However, liquid helium contained in a tank tends to evaporate into helium gas because it is practically difficult to maintain the temperature of the tank below 4 K. If the liquid helium contained in the tank continuously evaporates into the helium gas, however, the water level of the liquid helium contained in the tank is lowered due to the pressure of the helium gas resulting from the evaporation of the liquid helium, such that a sufficient amount of liquid helium cannot be injected into the liquid helium. Also, if the helium gas leaks outside of the tank, there is an economic loss because helium is expensive.

In order to overcome such problems, a conventional apparatus for condensing helium is disposed in the tank.

The conventional apparatus is configured such that the helium gas resulting from the evaporation of the liquid helium in the tank is extracted from the tank by a pump, is liquefied by a separate device, which is located outside the tank and uses a large heat exchanger, and then is injected again in liquid form in the tank.

However, the conventional apparatus is complex, large, and expensive, and takes up much space because it needs to be installed outside the tank.

### SUMMARY OF THE INVENTION

The present invention provides a helium condenser, which is disposed in a helium tank, has a small size, and provides high cooling efficiency, and an apparatus for condensing helium, the apparatus including the helium condenser.

According to an aspect of the present invention, there is provided a pileus-gills type helium condenser comprising: a body having a hemispheric shape and formed of a highly thermally conductive metal; a plurality of cooling fins collectively having a pileus gills-like shape and arranged along the circumference of the body to be spaced apart from one another; and a through-hole formed in the center of the body to be adjacent to the cooling fins.

The pileus-gills type helium condenser may further comprise an auxiliary cooling cap coupled to an upper portion of the body and covering the cooling fins to be spaced apart from the cooling fins.

The pileus-gills type helium condenser may further comprise: a helium guide part having a conical shape and inserted into the through-hole; and a connecting part coupled to the auxiliary cooling cap.

According another aspect of the present invention, there is provided an apparatus for condensing helium, the apparatus comprising the pileus-gills type helium condenser.

The apparatus may further comprise a helium retrieving pipe disposed under the pileus-gills type helium condenser and comprising a taper part whose cross-sectional area increases toward the pileus-gills type helium condenser.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of an apparatus for condensing helium, according to an embodiment of the present invention;

FIG. 2 is an exploded perspective view of a pileus-gills type helium condenser of the apparatus of FIG. 1, according to an embodiment of the present invention;

FIG. 3 is an assembled perspective view of the pileus-gills type helium condenser of FIG. 2;

FIG. 4 is an enlarged view of portion “A” of FIG. 3;

FIG. 5 is a perspective view of the pileus-gills type helium condenser of FIG. 3 viewed in a different direction from that in which the pileus-gills type helium condenser of FIG. 3 is viewed;

FIG. 6 is a perspective view illustrating cooling fins of the pileus-gills type helium condenser of FIG. 2; and

FIG. 7 is a partial cutaway view of the apparatus of FIG. 1.

### DETAILED DESCRIPTION OF THE INVENTION

The present invention will now be described more fully with reference to the accompanying drawings, in which exemplary embodiments of the invention are shown.

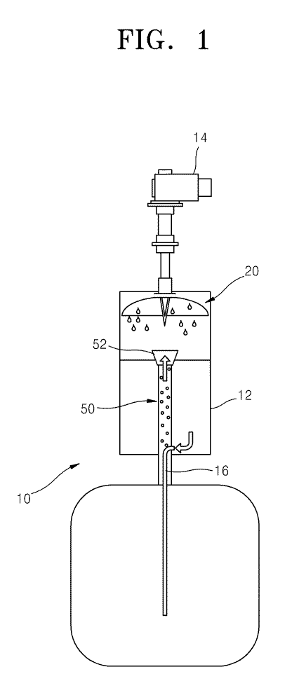

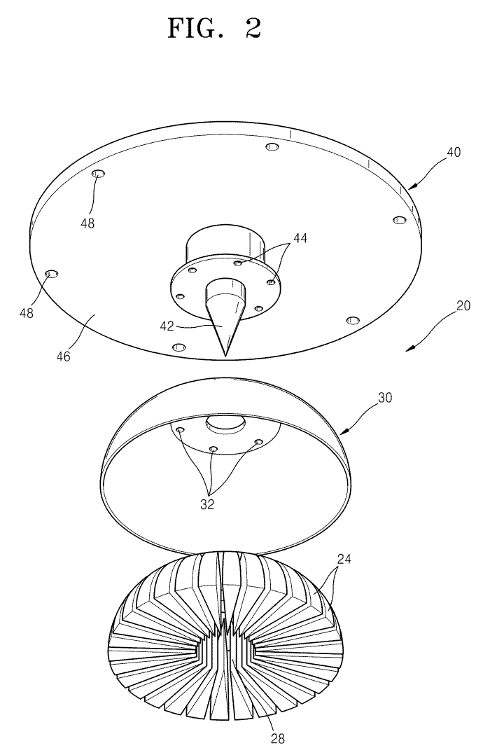

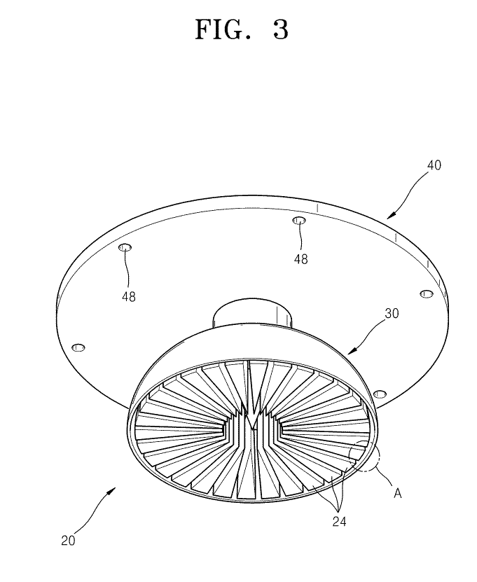

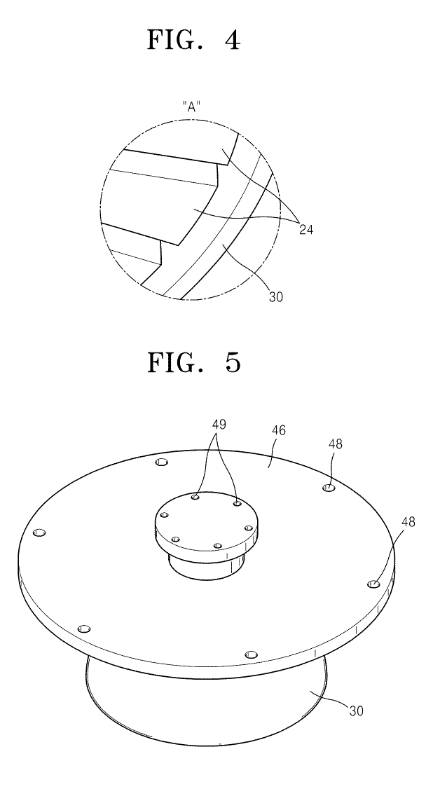

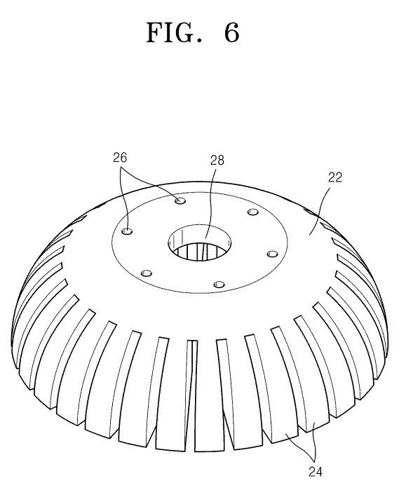

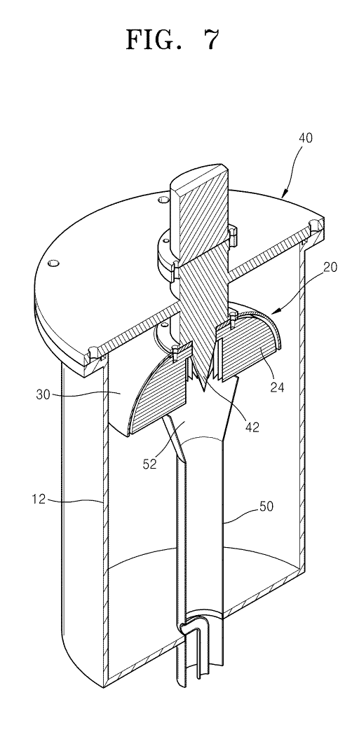

FIG. 1 is a cross-sectional view of an apparatus 10 for condensing helium, according to an embodiment of the present invention. FIG. 2 is an exploded perspective view of a pileus-gills type helium condenser 20 of the apparatus 10 of FIG. 1, according to an embodiment of the present invention. FIG. 3 is an assembled perspective view of the pileus-gills type helium condenser 20 of FIG. 2. FIG. 4 is an enlarged view of portion “A” of FIG. 3. FIG. 5 is a perspective view of the pileus-gills type helium condenser 20 of FIG. 3 viewed in a different direction from that in which the pileus-gills type helium condenser of FIG. 3 is viewed. FIG. 6 is a perspective view illustrating cooling fins 24 of the pileus-gills type helium condenser 20 of FIG. 2. FIG. 7 is a partial cutaway view of the apparatus 10 of FIG. 1.

Referring to FIGS. 1 through 7, the apparatus 10 uses natural convection, and thus it does not require a separate pump.

The apparatus 10 includes a tank 12 containing liquid helium, and a Gifford-McMahon refrigerator (referred to as a refrigerator hereinafter) disposed over the tank 12 and maintaining the temperature of the pileus-gills type helium condenser 20 below 4 K. The refrigerator 14 is commonly known and thus a detailed explanation thereof will not be given. A liquid helium supply pipe 16 and a liquid helium retrieving pipe 50 are installed in the tank 12. The liquid helium supply pipe 16 supplies liquid helium to the tank 12. The liquid helium retrieving pipe 50 retrieves helium gas resulting from the evaporation of the liquid helium from the tank 12 and supplies the retrieved helium gas to the pileus-gills type helium condenser 20.

The apparatus 10 includes the pileus-gills type helium condenser 20.

The pileus-gills type helium condenser 20 includes a body 2, cooling fins 24, an auxiliary cooling cap 30, and a connecting member 40.

The body 22 is formed of highly thermally conductive oxygen-free copper. Here, oxygen-free copper refers to high quality copper that has a purity of higher than 99.99%, an oxygen content of less than 10 ppm, an electrical conductivity of higher than 101% international annealed copper standard (IACS). Also, the oxygen-free copper has high electrical conductivity, thermal conductivity, formability, bendability, resistance to hydrogen embrittlement, and processability.

The body 22 has a hemispheric shape. A through-hole 28 is formed in the center of the body 22. The through-hole 28 is adjacent to the cooling fins 24. A plurality of coupling grooves 26 are formed in an upper portion of the body 22. A female screw is formed on an inner circumferential surface of each of the coupling grooves 26. The auxiliary cooling cap 30 and the connecting member 40 are coupled to the body 22 by the coupling grooves 26.

The cooling fins 24 are integrally formed with the body 22. The cooling fins 24 increase an area contacting helium. The cooling fins 24 have a pileus gills-like shape. That is, as shown in FIG. 6, the cooling fins 22 consist of a plurality of pieces that are arranged along the circumference of the body 22 and are divided by slits. The cooling fins 24 act as heat exchangers. Upper portions of the cooling fins 24 are integrally formed with the body 22. The cooling fins 24 may be formed by laser beam machining or discharge machining.

The auxiliary cooling cap 30 covers the upper portion of the body 22. The auxiliary cooling cap 30 has a hemispheric shape. The auxiliary cooling cap 30 may be formed of oxygen-free copper like the body 22. The auxiliary cooling cap 30 is coupled to the upper portion of the body 22. That is, the auxiliary cooling cap 30 includes a plurality of first coupling holes 32. The first coupling holes 32 are formed to correspond in position to the coupling grooves 26 formed in the body 22. The auxiliary cooling cap 30 covers the cooling fins 24 in such a manner that the auxiliary cooling cap is spaced by a small distance from the cooling fins 24. FIG. 4 is an enlarged view illustrating that the cooling fins 24 and the auxiliary cooling cap 30 are spaced apart from each other by the small distance.

The body 22 is connected to the refrigerator 14 by the connecting member 40. The connecting member 40 may be formed of oxygen-free copper like the body 22. The connecting member 40 includes a helium guide part 42, second coupling holes 44, and a flange 46. The helium guide part 42 has a conical shape, and is inserted into the through-hole 28. The helium guide part 42 enables helium gas, which results from the evaporation of liquid helium contained in the tank 12, to naturally collide with the cooling fins 24. In detail, the helium guide part 42 guides the helium gas so that the helium gas can more easily flow between the cooling fins 24.

The second coupling holes 44 are formed to correspond in position to the first coupling holes 32 of the auxiliary cooling cap 30 and the coupling grooves 26 of the body 22. As shown in FIG. 3, the connecting member 40, the auxiliary cooling cap 30, and the body 22 are screwed to the pileus-gills type helium condenser 20 by sequentially passing fastening means, such as bolts, through the second coupling holes 44 and the first coupling holes 32. The flange 46 is an upper portion of the connecting member 40. The refrigerator 14 and the pileus-gills type helium condenser 20 are coupled to each other by the flange 46. A plurality of insertion holes 48 for coupling the tank 12 to the pileus-gills type helium condenser 20 are formed in the flange 46. The tank 12 and the pileus-gills type helium condenser 20 are coupled to each other by passing fastening means, such as bolts, through the insertion holes 48. A plurality of assembly holes 49 for coupling the refrigerator 14 to the pileus-gills type helium condenser 20 are formed in the center of the flange 48.

The liquid helium retrieving pipe 50 is disposed under the pileus-gills type helium condenser 20. The liquid helium retrieving pipe 50 includes a taper part 52 whose cross-sectional area increases toward the pileus-gills type helium condenser 20. The taper part 52 enables the helium gas resulting from the evaporation of the liquid helium contained in the tank 12 to effectively flow into the pileus-gills type helium condenser 20.

The operation of the apparatus 10 constructed as described above will now be explained with reference to a path through which helium flows when the helium condenser 20 is installed in the apparatus 10. It is assumed that the helium condenser 20 is installed in the tank 12 as shown in FIG. 1.

Helium molecules of liquid helium contained in the tank 12 evaporate from a water surface into helium gas. The helium gas moves upward in the tank 12. The helium gas collides with the cooling fins 24 of the pileus-gills type helium condenser 20 which are installed in an upper portion of the tank 12. The temperature of the cooling fins 24 is maintained below 4 K by the refrigerator 14. Since the cooling fins 24 have a very large surface area, the cooling fins 24 effectively transfer heat of the helium gas and help the helium gas to be liquefied. In this process, the helium guide part 42 naturally guides the helium gas to the cooling fins 24. The helium gas passing through the slits formed between the pieces of the cooling fins 24 collides with the auxiliary cooling cap 30 covering the cooling fins 24. Since the temperature of the auxiliary cooling cap 30 is maintained below 4 K by the refrigerator 14, the helium gas is liquefied. The helium gas colliding with the cooling fins 24 and the auxiliary cooling cap 30 transfers its heat to the cooling fins 24 and the auxiliary cooling cap 30, is liquefied, and is retrieved to the tank 12. The taper part 52 formed on the liquid helium retrieving pipe 50 more effectively guides the helium gas from the tank 12 to the pileus-gills type helium condenser 20.

Since the apparatus 10 has a maximum cooling area due to the pileus-gills type helium condenser 20, the heat of the helium gas can be effectively transferred to the cooling fins 24 and the helium gas can be liquefied with high yield. Also, the helium guide part 42 can naturally guide the helium gas to the cooling fins 24 that are cooling media. Also, the auxiliary cooling cap 30 can additionally cool and liquefy some of the helium gas not contacting the cooling fins 24.

Although the pileus-gills type helium condenser 20 of FIGS. 1 through 7 includes the auxiliary cooling cap 30 that is coupled to the upper portion of the body 2, is spaced apart from the cooling fins 24, and covers the cooling fins 24, the present invention is not limited thereto and the auxiliary cooling cap 30 may be omitted.

Although the pileus-gills type helium condenser 20 of FIGS. 1 through 7 includes the connecting member 40 that includes the conical helium guide part 42 inserted into the through-hole 28 and is coupled to the auxiliary cooling cap 30, the present invention is not limited thereto and the connecting member 40 may be omitted as long as the refrigerator 14 can be properly coupled to the pileus-gills type helium condenser 20.

Although the apparatus 10 of FIGS. 1 through 7 includes the helium retrieving pipe 50 that is disposed under the pileus-gills type helium condenser 20 and includes the taper part 52 whose cross-sectional area increases toward the pileus-gills type helium condenser 20, the present invention is not limited thereto and the taper part 52 may be omitted.

As described above, the pileus-gills type helium condenser according to the present invention can achieve maximum cooling efficiency, even with a small structure, by significantly increasing the surface area of the cooling fins contacting and cooling helium.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A pileus-gills type helium condenser comprising:
a body having a hemispheric shape and formed of a highly thermally conductive metal;
a plurality of cooling fins collectively having a pileus gills-like shape and arranged along the circumference of the body to be spaced apart from one another; and
a through-hole formed in the center of the body to be adjacent to the cooling fins.

2. The pileus-gills type helium condenser of claim 1, further comprising an auxiliary cooling cap coupled to an upper portion of the body and covering the cooling fins to be spaced apart from the cooling fins.

3. The pileus-gills type helium condenser of claim 2, further comprising:
a helium guide part having a conical shape and inserted into the through-hole; and
a connecting part coupled to the auxiliary cooling cap.

4. An apparatus for condensing helium, the apparatus including a pileus-gills type helium condenser comprising:
a body having a hemispheric shape and formed of a highly thermally conductive metal;
a plurality of cooling fins collectively having a pileus gills-like shape and arranged along the circumference of the body to be spaced apart from one another; and
a through-hole formed in the center of the body to be adjacent to the cooling fins.

5. The apparatus of claim 4, further comprising a helium retrieving pipe disposed under the pileus-gills type helium condenser and comprising a taper part whose cross-sectional area increases toward the pileus-gills type helium condenser.

6. The apparatus of claim 5, wherein the pileus-gills type helium condenser further comprising an auxiliary cooling cap coupled to an upper portion of the body and covering the cooling fins to be spaced apart from the cooling fins.

7. The apparatus of claim 5, wherein the pileus-gills type helium condenser further comprising:
a helium guide part having a conical shape and inserted into the through-hole; and
a connecting part coupled to the auxiliary cooling cap.
